(19) United States
(12) Patent Application Publication
(10) Pub. No.: US 2025/0162861 A1
(43) Pub. Date: May 22, 2025

(54) Surface Structuring of Additively Manufactured Articles

(71) Applicants: Nanyang Technological University, Singapore (SG); The Board of Trustees of the University of Illinois, Urbana, IL (US)

(72) Inventors: Jin Yao Ho, Singapore (SG); Kazi Fazle Rabbi, Urbana, IL (US); Teck Neng Wong, Singapore (SG); Kai Choong Leong, Singapore (SG); William P. King, Champaign, IL (US); Nenad Miljkovic, Urbana, IL (US)

(21) Appl. No.: 18/729,066

(22) PCT Filed: Jan. 19, 2023
(86) PCT No.: PCT/SG2023/050039

§ 371 Date: Jul. 15, 2024

Related U.S. Application Data
(60) Provisional application No. 63/302,648, filed on Jan. 25, 2022.

(51) Int. Cl. B82B 1/00; B22F 3/11; B22F 3/24; B33Y 10/00; B33Y 80/00; B82B 3/00

(52) U.S. Cl. CPC B82B 1/001; B22F 3/1115; B22F 3/24; B82B 3/0019; B22F 2003/244; B22F 2301/052; B33Y 10/00; B33Y 80/00

(57) ABSTRACT

A selected surface of the present disclosure is characterized by a two-tier nanostructure: first-tier nanostructures and second-tier nanostructures disposed on at least a cell wall of the first-tier nanostructures. The first-tier nanostructures define a network of cells, each with a cell wall and a recessed core. The core is predominantly formed of a first phase of an additively formed aluminum alloy, and the cell wall is predominantly formed of a second phase of the same additively formed aluminum alloy. A method of forming the two-tier nanostructure includes preferential etching of the core over the cell wall to form a network of open cells, and a self-limiting formation of the second-tier nanostructure to form a plurality of sub-cavities characterized by nanoscale dimensions smaller than the cell opening of a cell.

The present application claims the benefit of priority to the U.S. patent application No. 63/302,648 filed on Jan. 25, 2022, the contents of which are hereby incorporated by reference in entirety for all purposes.

### TECHNICAL FIELD

The present disclosure relates to additive manufacturing, and more particularly to a method of surface structuring of additively manufactured articles and the articles thereof.

### BACKGROUND

Engineering of surface structures have to take into consideration multiple aspects, such as coalescence-induced droplet jumping, single droplet self-propulsion, droplet bouncing and capillary-induced droplet dewetting, etc. Despite continuous efforts, development of a surface structure that can satisfy multi-functional performance enhancements remains challenging.

### SUMMARY

In one aspect, the present application discloses an article, the article comprising: a selected surface having: a first plurality of a first-tier nanostructure; and a second plurality of a second-tier nanostructure. The first-tier nanostructure includes: a cell wall, the cell wall being columnar; and a core, the core being surrounded by the cell wall and recessed inwardly to define a stepped surface relative to a general plane of the selected surface, the stepped surface and the cell wall defining a cell cavity with a cell opening at the selected surface, the cell opening having a cell diameter. The second plurality of a second-tier nanostructure is disposed on at least the cell wall of the first-tier nanostructure, with the second plurality of the second-tier nanostructure extending into the cell cavity such that the cell cavity includes a plurality of sub-cavities, the plurality of sub-cavities being characterized by nanoscale dimensions smaller than the cell diameter. The core is predominantly formed of a first phase of an additively formed aluminum alloy, and wherein the cell wall is predominantly formed of a second phase of the additively formed aluminum alloy.

Preferably, the cell opening is in fluidic communication with the plurality of sub-cavities.

Preferably, the selected surface comprises a network of a plurality of the cell opening, and wherein adjacent ones of the plurality of the cell opening are separated by contiguous ones of a plurality of the cell wall.

Preferably, the first phase of the additively formed aluminum alloy is more reactive in an etchant than the second phase of the additively formed aluminum alloy in the etchant.

Preferably, the additively formed aluminum alloy is formed from a powder of AlSi10Mg, and wherein the second phase of the additively formed aluminum alloy has a higher silicon content relative to the first phase of the additively formed aluminum alloy.

The second-tier nanostructure may comprise an oxide of the additively formed aluminum alloy. Preferably, the second-tier nanostructure is composed of boehmite.

The second plurality of the second-tier nanostructure may comprise the second phase of the additively formed aluminum alloy. The second-tier nanostructure may be monolithic with the cell wall of at least one of the first plurality of the first-tier nanostructure.

The selected surface may be characterized by a surface property resulting from a functionalization of at least the second plurality of the second-tier nanostructure.

In another aspect, the present application discloses an article comprising a heat exchanger, the heat exchanger having: a coolant flow channel; and an external surface of the coolant flow channel, wherein at least a part of the external surface is configured as the selected surface.

In another aspect, the present application discloses a method comprising: etching a selected surface of an article using an etchant; and forming a second plurality of a second-tier nanostructure on at least the cell wall of the first-tier nanostructure, not necessarily in the order state. The method includes etching of a selected surface of an article using an etchant to form a first plurality of a first-tier nanostructure, wherein the first-tier nanostructure includes: a cell wall, the cell wall being columnar; and a core, the core being surrounded by the cell wall and recessed inwardly to define a stepped surface relative to a general plane of the selected surface, the stepped surface and the cell wall defining a cell cavity with a cell opening at the selected surface, the cell opening having a cell diameter. The method includes forming a second plurality of a second-tier nanostructure on at least the cell wall of the first-tier nanostructure, the second plurality of the second-tier nanostructure extending into the cell cavity such that the cell cavity includes a plurality of sub-cavities, the plurality of sub-cavities being characterized by nanoscale dimensions smaller than the cell diameter, wherein the core is predominantly formed of a first phase of an additively formed aluminum alloy, and wherein the cell wall is predominantly formed of a second phase of the additively formed aluminum alloy

Preferably, the etching comprises a preferential etching of the first phase of the additively formed aluminum alloy over the second phase of the additively formed aluminum alloy. Preferably. the etching comprises a preferential etching of the core over the cell wall, forming a network of a plurality of the cell opening, and wherein adjacent ones of the plurality of the cell opening are separated by contiguous ones of a plurality of the cell wall.

The forming of the second plurality of the second-tier nanostructure may comprise a self-limiting formation of the second plurality of the second-tier nanostructure. Preferably. the second-tier nanostructure is monolithic with the cell wall of at least one of the first plurality of the first-tier nanostructure.

The forming of the second plurality of the second-tier nanostructure may comprise heat treatment of the selected surface before the etching. The second plurality of the second-tier nanostructure may comprise the second phase of the additively formed aluminum alloy.

The forming of the second plurality of the second-tier nanostructure may comprise boehmitizing the selected surface after the etching. The second-tier nanostructure may be composed of boehmite.

The method may be characterized in that the additively formed aluminum alloy is formed from a powder of AlSi10Mg, and the second phase of the additively formed aluminum alloy has a higher silicon content relative to the first phase of the additively formed aluminum alloy.

The method may further comprise functionalizing the selected surface, the selected surface being characterized by a surface property resulting from a functionalization of at least the second plurality of the second-tier nanostructure. The functionalizing may comprise silanizing the selected surface.

### BRIEF DESCRIPTION OF DRAWINGS

FIGS. 1 to 3 are schematic illustrations of a two-tiered nanostructured surface of an additively manufactured article formed according to embodiments of the present disclosure;

FIG. 4 is a schematic flow diagram of a method according to embodiments of the present disclosure;

FIGS. 5A to 5C schematically illustrate the one embodiment of the method in which etching is performed before forming the second-tier nanostructures;

FIGS. 6A to 6D are SEM images of a selected surface after various etch times.

FIGS. 7A to 7D are SEM images of an Al-6061 sample after various etch times;

FIG. 8A is a chart showing the XPS result of an additively manufactured article;

FIG. 8B is a chart showing the XPS result of an additively manufactured article after etching and before boehmitization;

FIG. 8C is a chart showing the XPS result of an Al-6061 sample;

FIG. 8D is a chart showing the XPS result of an Al-6061 sample after etching;

FIG. 9 are plots of the advancing contact angle of the selected surface after etching and before boehmitization and the advancing contact angle of a conventional aluminum alloy after etching;

FIG. 10 is an SEM image of the selected surface, after etching and before boehmitization;

FIG. 11 is an SEM image of the selected surface of FIG. 10 after boehmitization;

FIG. 12 is a schematic representation of an additively manufactured condenser;

FIGS. 13A to 13C schematically illustrate the another embodiment in which etching is performed after heat treatment;

FIG. 14A is an SEM image of the selected surface of FIGS. 13A to 13C, after heat treatment at 300° C. and after etching;

FIG. 14B is a magnified view of FIG. 14A;

FIG. 15A is an SEM image of the selected surface of FIGS. 14A to 14C, after heat treatment at 400° C. and after etching.

FIG. 15B is a magnified view of FIG. 15A.

FIG. 16 is a chart illustrating the advancing contact angle of an additively manufactured article after heat treatment at 300° C. and 400° C., respectively;

FIG. 17A illustrates water droplet contact angle of the article of FIG. 13C without etching;

FIG. 17B illustrates water droplet contact angle of the article of FIG. 13C after etching for 2.5 min;

FIG. 17C illustrates water droplet contact angle of the article of FIG. 13C after etching for 5.0 min;

FIG. 17D illustrates water droplet contact angle of the article of FIG. 13C after etching for 7.5 min;

FIG. 18A illustrates a scheme of droplet impact on an article before heat treatment and etching;

FIG. 18B illustrates a scheme of droplet impact on an article after heat treatment at 300° C. and etching;

FIG. 18C illustrates a scheme of droplet impact on an article after heat treatment at 400° C. and etching;

FIG. 19A illustrates the droplet departure and droplet pinning mechanism at a side view on the article without heat treatment and after etching;

FIG. 19B illustrates the droplet departure and droplet pinning mechanism at a top view on the article without heat treatment and after etching;

FIG. 19C illustrates the droplet departure and droplet pinning mechanism at a side on the article after heat treatment at 300° C. and etching; and

FIG. 20 is a chart illustrating a regime map for surface structuring of additively manufactured alloys.

### DETAILED DESCRIPTION

Reference throughout this specification to “one embodiment”, “another embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment. Furthermore, the described features, structures, or characteristics may be combined in any suitable manner in one or more embodiments. In the following description, numerous specific details are provided to give a thorough understanding of embodiments. One skilled in the relevant art will recognize, that the various embodiments be practiced without one or more of the specific details, or with other methods, components, materials, etc. In other instances, some or all known structures, materials, or operations may not be shown or described in detail to avoid obfuscation.

The word “exemplary” is used herein to mean “serving as an example, instance, or illustration.” Any embodiment described herein as “exemplary” is not necessarily to be construed as preferred or advantageous over other embodiments. As used herein, the singular ‘a’ and ‘an’ may be construed as including the plural “one or more” unless apparent from the context to be otherwise.

The terms “about” and “approximately” as applied to a stated numeric value encompasses the exact value and a reasonable variance as will be understood by one of ordinary skill in the art, and the terms “generally” and “substantially” are to be understood in a similar manner, unless otherwise specified.

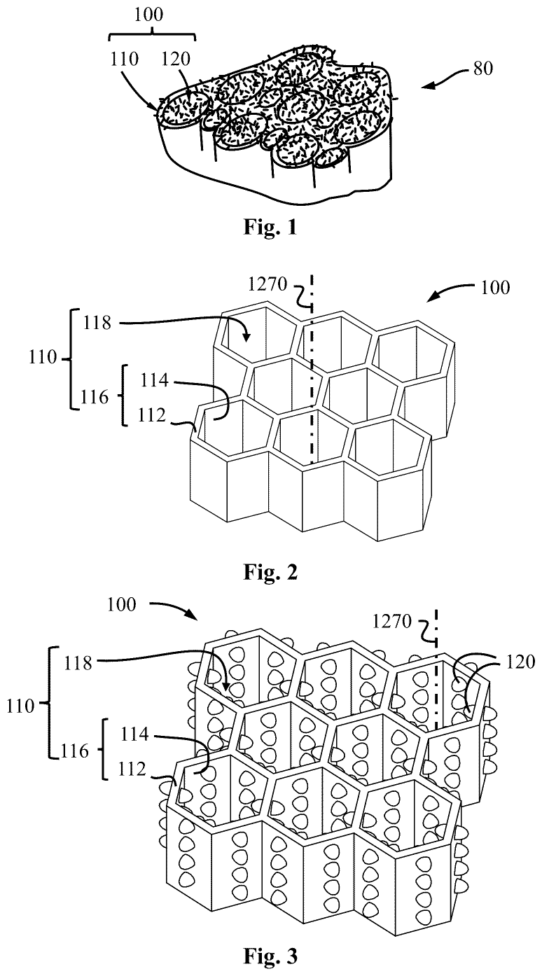

According to one embodiment of the present disclosure, there is provided a two-tiered nanostructured surface 100 on an article 80. The surface 100 includes a plurality of a first-tier nanostructure 110 and a plurality of a second-tier nanostructure 120, with the second plurality of the second-tier nanostructure 120 being disposed on/in the plurality of the first-tier nanostructures 110. The first-tier nanostructures 110 define one or more cell cavities or recessed cores, each surrounded by a cell wall, such that the selected surface 100 may be described as a three-dimensional surface. The second-tier nanostructures 120 are protrusions or extensions in or around the cell cavities 110, as illustrated schematically in FIG. 1.

Reference is made to FIG. 2 which provides a partial schematic representation of an outermost portion of the two-tiered nanostructured surface 100. To avoid obfuscation, the first-tier nanostructures 110 are shown without the second-tier nanostructures. The first-tier nanostructures 110 are represented as substantially geometric shapes merely to aid understanding and not to be limiting. The first-tier nanostructures 100 may be open-ended cells or cells with cell openings on the selected surface, i.e., with the cell cavities 118 of the cells exposed. The first-tier nanostructures 110 may be organized as an open network of cellular structures or as a network of cells with open ends. The first-tier nanostructures 110 or cells may be characterized by a substantially columnar aspect ratio, i.e., the cells may be columnar. Each cell may be defined by a cell wall 116, with a side cell wall 114 surrounding or defining an open cell cavity 118. The cells 110 may be of different sizes (i.e., cell walls 116 of differing thicknesses and/or cell cavities 118 of differing average diameters). The first-tier nanostructures 110 may be columnar and substantially aligned or oriented in a similar nominal axial orientation or elongation direction 1270.

FIG. 3 schematically illustrates a plurality of the second-tier nanostructures 120 disposed on the first-tier nanostructures 110 of FIG. 2. The figures appended to the present application are not drawn to scale, but it can be appreciated from the figures that the second-tier nanostructures 120 include a plurality of nanoscale features of dimensions or a scale smaller than that of the first-tier nanostructures 110. Each first-tier nanostructure 110 may have a plurality of second-tier nanostructures 120 disposed thereon in a substantially random manner or in a substantially regular manner. That is, the selected surface 100 of the article 80 may include a first plurality of the first-tier nanostructure 116 with a second plurality of the second-tier nanostructure 120 disposed on each of the first plurality of the first-tier nanostructure. The second-tier nanostructures 120 may be bump-like features, extended features, or protrusions disposed on the side cell wall 114 and extending into the cell cavity 118 or away from a general plane of the selected surface of the article 80. The second-tier nanostructures 120 may be oriented in various different orientations relative to the nominal axial orientation 1270 of the substantially columnar first-tier nanostructures 110. Within a larger cell cavity 118 defined by the first-tier nanostructures is a plurality of contiguous or non-contiguous smaller sub-cavities, in which the sub-cavities are at least partially defined by the second-tier nanostructures 120.

The selected surface 100 can be described as a two-tier nanostructure made up of a first plurality of a first-tier nanostructure 110 and a second plurality of a second-tier nanostructure 120. The first-tier nanostructure 110 includes a cell wall 116 in which the cell wall is preferably columnar. The first-tier nanostructure 110 also includes a core 117. The core 117 is surrounded by the cell wall 116 and recessed inwardly to define a stepped surface 115 relative to a general plane 102 of the selected surface 100. The general plane 102 may refer to the plane substantially coinciding with the selected surface 100 before any etching away of materials. The stepped surface and the cell wall define a cell cavity 118 which opens to the selected surface 100 at a cell opening 113. The cell openings 113 of the first-tier nanostructures 110 on the same selected surface 100 may differ from cell to cell. Preferably, the cell openings 113 of the same network of cells have cell diameters of about the same size, hereinafter referred to as a cell diameter for the sake of brevity. The second plurality of the second-tier nanostructure 120 is disposed on at least the cell wall 116 of the first-tier nanostructure 110, with the second plurality of the second-tier nanostructure 120 of the same first-tier nanostructure extending into the cell cavity 118. The cell cavity 118 can be described as including a plurality of sub-cavities 119. The plurality of sub-cavities 119 are characterized by nanoscale dimensions smaller than the cell diameter of the cell. The core 117 is predominantly formed of a first phase of an additively formed aluminum alloy, and wherein the cell wall 116 is predominantly formed of a second phase of the additively formed aluminum alloy. Preferably, the cell opening 113 is in fluidic communication with the plurality of sub-cavities 119. Preferably, the selected surface 100 comprises a network of a plurality of the cell opening 113, and wherein adjacent ones of the plurality of the cell opening 133 are separated by contiguous ones of a plurality of the cell wall 116.

Various materials may be selected for additively forming articles and/or forming the two-tiered nanostructured surfaces thereon in accordance with embodiments of the present disclosure. The material selected is preferably one which is characterized by an epitaxial growth of crystals and produces nano-size columnar sub-grain structures. The columnar sub-grain structures are characterized by the concurrent presence of a first phase and a second phase, in which the first phase is relatively rich in a first element and the second phase is relatively rich in a second element. The material is selected such that, on being additively formed, each columnar sub-grain structure has a core 117 of the first phase and a cell wall 116 of the second phase, and such that in the presence of the same etchant, there is differential or preferential etching of the first phase over the second phase. Preferably, the additively formed material is an aluminum alloy formed from a powder of AlSi10Mg, and wherein the second phase of the additively formed aluminum alloy has a higher silicon content relative to the first phase of the additively formed aluminum alloy. Preferably, the etchant and the alloys are selected so that the first phase of the additively formed aluminum alloy is more reactive in the etchant than the second phase of the additively formed aluminum alloy in the same etchant.

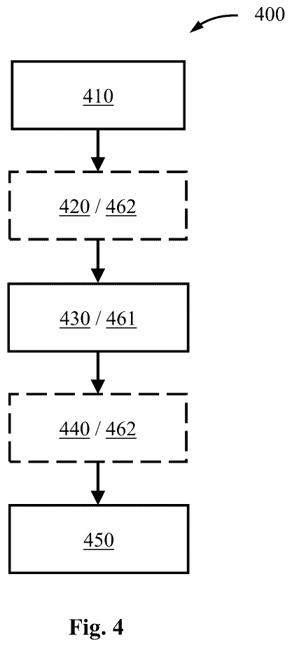

Another aspect of the present disclosure relates to a method 400 of forming the three-dimensional two-tiered nanostructured surface 100 on an additively manufactured article 80. Referring to the schematic flow diagram of FIG. 4, according to one embodiment of the present disclosure, the method 400 may include a two-stage process: a first stage 461 of preferential etching of a first phase of an additively manufactured alloy over a second phase present on the same selected surface 100, and a second stage 462 of a self-limiting formation of second-tier nanostructures. According to one embodiment of the method 400, the first stage 461 of etching is performed before the second stage 462 of the self-limiting formation of second-tier nanostructures. According to another embodiment of the method, the first stage of etching 461 is performed after the second stage 462 of the self-limiting formation of second-tier nanostructures 120. In FIG. 4, the blocks for the second stage 462 are shown in dashed lines to indicate the different variations.

The method 400 may include a process of additively manufacturing the article (410). Alternatively, the method 400 may include selecting an additively manufactured article. The method 400 may include heat treatment (420) of the additively manufactured article 80 prior to etching (430) as at least a part of the self-limiting formation of the second-tier nanostructures 120. The method 400 may further or alternatively include oxidizing or boehmitizing (440) the selected surface 100 after etching (430), as at least a part of the self-limiting formation of the second-tier nanostructures 120. Preferably, the method 400 includes, after formation of the first-tier nanostructures 110 and the second-tier nanostructures 120, at least one functionalization (450) such that the selected surface 100 is characterized by a surface property resulting from a functionalization of at least the second plurality of the second-tier nanostructure 120.

To demonstrate the practical use and benefit of the embodiments disclosed herein and not to be limiting, exemplary articles were additively manufactured using AlSi10Mg as a base powder. In the experiments, the AlSi10Mg powder used have diameters ranging from about 20 to about 63 μm.

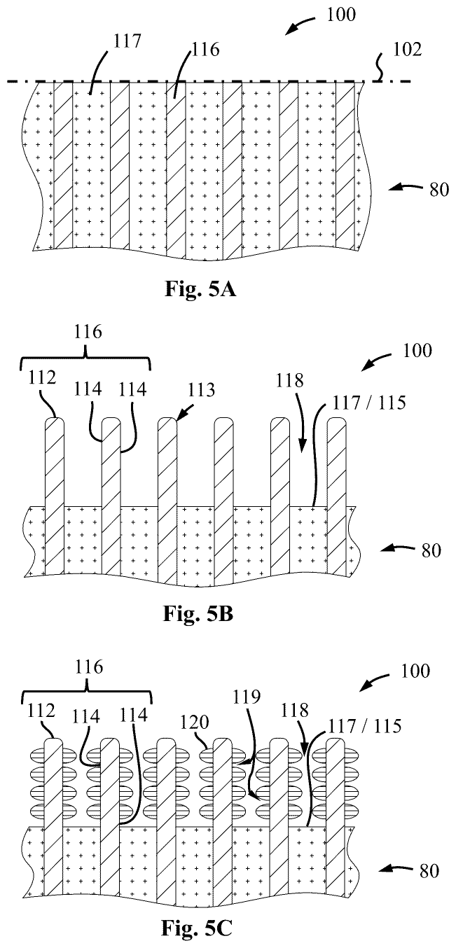

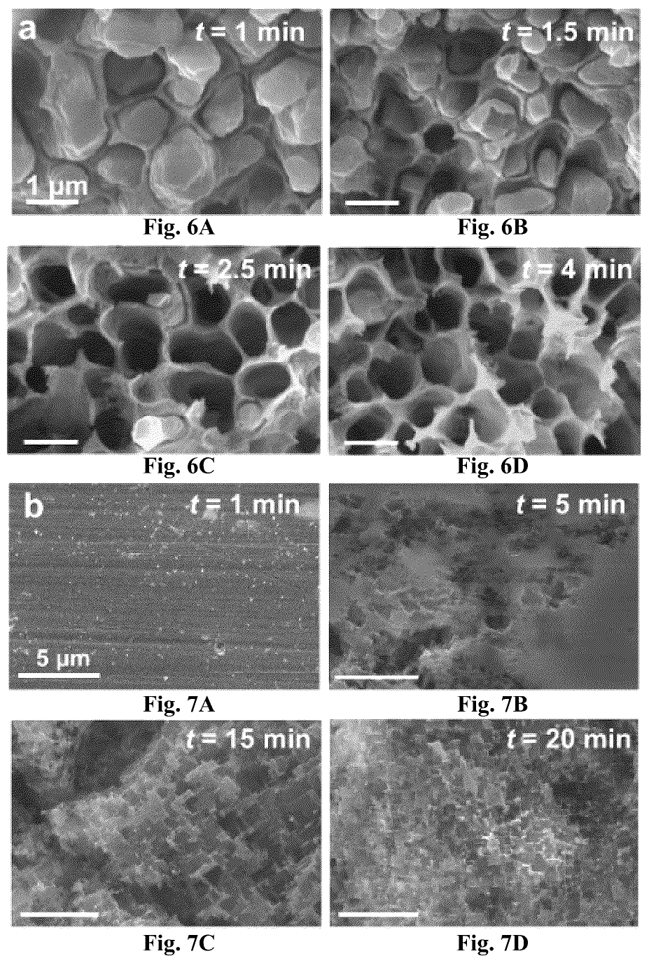

FIGS. 5A to 5C are schematic diagrams illustrating one embodiment of the present disclosure, and FIGS. 6A to 6C are schematic diagrams illustrating another embodiment of the present disclosure.

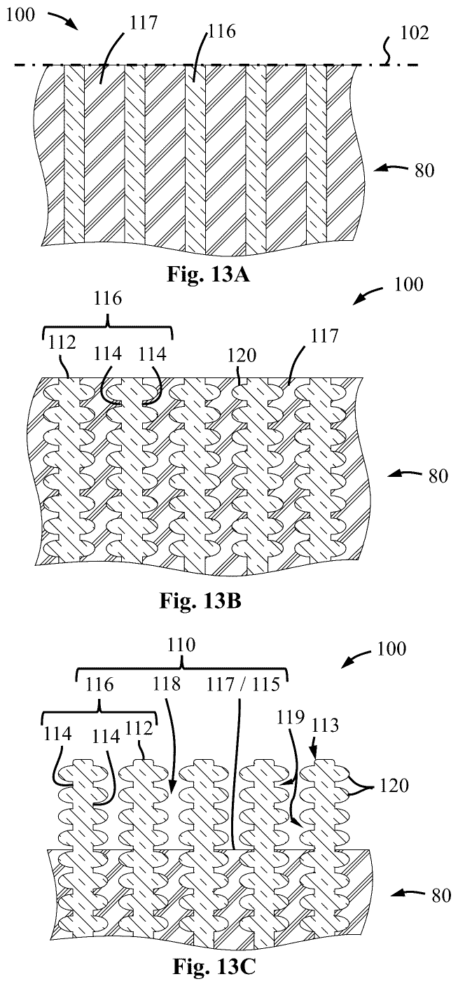

The article 80 may be formed using a metal additive manufacturing process such as selective laser melting (SLM). The SLM apparatus may be configured to utilize a Gaussian distributed Yb:YAG laser source with a maximum power of 400 W. Exemplary and non-limiting process parameters include a laser power of 200 W (watts), a laser scanning speed of 1300 mm/s (millimeters per second) and a hatch spacing of 0.08 mm (millimeters). During the SLM process, as the powder melts, ultra-thin melt pools with a diameter of about 50 μm (micrometers) may be formed. As these melt pools cool and solidify, a relatively dense solid layer is formed. By successively melting and fusing the powder bed layer-by-layer, the article is formed. In the solidification process during SLM, nano-scale sub-grain structures are produced as shown in the schematic diagrams of FIG. 5A or FIG. 13A. The nano-scale sub-grain structures are not found in an article fabricated using conventional processes such as casting, rolling, etc., In the experiments, the nano-scale sub-grain structures of the additively manufactured (AM) alloy 80 include a nano-sized cellular network with silicon-rich aluminum-silicon (Al—Si) cell walls 116, and Al-rich Al—Si cores 117. The selected surface 100 defines a general plane 102.

The article 80 may be on a base plate made of aluminum during the additive manufacturing process. The as-fabricated article may be removed from the base plate using a wire electrical discharge machining (EDM). The remaining un-melted powder may be processed and reused. The article 80 may be cleaned after it is removed from the base plate. For example, the article 80 may be immersed in acetone, ethanol, and isopropyl alcohol separately or in turn, and ultrasonicated for about 10 minutes in each immersion. Thereafter, the article 80 may be rinsed with deionized water and dried with a nitrogen stream.

At the selected surface 100 of the article 80, a selected surface 100 of an additively manufactured article 80 is etched using an etchant that is more reactive with the first phase than with the second phase. The stage of etching (430) preferentially removes material from the cores 117 of the cellular structure of the additively manufactured surface 100 (in preference to removing material from the cell walls 116), such that more surface area of the cell walls 116 are exposed (e.g., comparing the exposed surface of the cell wall 116 as illustrated in FIG. 5A with the exposed parts of the outer surface 112 and side cell walls 114 as illustrated in FIG. 5B). Preferential etching of the cores 117 means that for the same etch time and the same etchant, more material will be removed from the cores 117 than from the cell walls 116. As used herein, the term “stepped structure” refers to the surface of the article 80 being made up of an outer surface 112 and a recessed surface 115, wherein the recessed surface 115 forms a distinct depression relative to the outer surface 112. The side cell walls 114 and the recessed surfaces 115 together define a corresponding plurality or network of cell cavities 118. As illustrated in FIG. 5B, after etching, a network of open cells is formed. That is, the selected surface 100 includes a network of a plurality of the cell opening 113, in which adjacent ones of the plurality of the cell opening 113 are separated by contiguous ones of a plurality of the cell wall 116.

A diluted 2.0 M hydrochloric acid solution may be used as an etchant. Etching may be carried out for an etching duration of about 2.5 minutes at room temperature. Alternatively, Keller's reagent, which includes a mixture of nitric acid, hydrochloric acid, and hydrofluoric acid, may be used in place of the hydrochloric acid solution. In one example, the selected surface of the article is first polished to a mirror-like finish using sandpaper of grit size 1000, 2000, 3000, 5000, and 7000, respectively. Thereafter, the selected surface of the article is cleaned by sonicating in acetone, ethanol, and isopropyl alcohol separately and in turn for about 10 minutes each. Once the selected surface is cleaned and air dried, it is immersed in the Keller's reagent, consisting of 2.5% HNO₃, 1.5% HCl, 1% HF and 95% water, for about 30 seconds. The article is then further ultrasonicated for about 20 minutes to remove residues and then dried with clean nitrogen gas.

After the stage of etching (430) has formed a plurality or a network of cells with recessed cores, a plurality of the second-tier nanostructures 120 in the form of boehmite or aluminum oxide hydroxide are formed on the cell walls 116, as shown in the schematic diagram of FIG. 5C. The chemical reaction (440) is selected from self-limiting reactions to provide additional and/or irregular features (second-tier nanostructures 120) at least on the exposed side walls 114. That is, the formation of the second-tier nanostructures 120 will stop after a time such that the cell cavities 118 are not entirely filled up by the second-tier nanostructures 120. The cell cavities 118 are reconfigured by the second-tier nanostructures to include a plurality of smaller sub-cavities 119.

FIG. 6A to FIG. 6D show scanning electron microscopy (SEM) images of a selected surface after various etch times (durations of etching). FIG. 6A shows the selected surface of an additively formed aluminum alloy article after etching for one minute (etch time of 1 min). The Al-rich cores and the Si-rich cell walls are distinguishable. Preferential etching of the cores over the cell walls results in a three-dimensional surface structure with relatively shallow cell cavities. As shown in FIG. 6B, after 1.5 minutes of etching, the cores can be etched to show deeper cell cavities. FIG. 6C and FIG. 6D are images after etch times of 2.5 minutes and four minutes, respectively. As shown, the depth of the cell cavities 118 can be configured by controlling the length of the etch time. In one example, the first-tier nanostructures 110 formed are characterized by substantially regular cell cavities 118 having diameters of about 1 μm (micrometer), bounded by cell walls 116 that are about 50 nm to 100 nm thick, with a cell cavity depth (step size) of about 1.5 μm. Using a laser scanning confocal microscope, it was verified from the high-resolution images obtained that etching reduces the macroscale roughness of the selected surface.

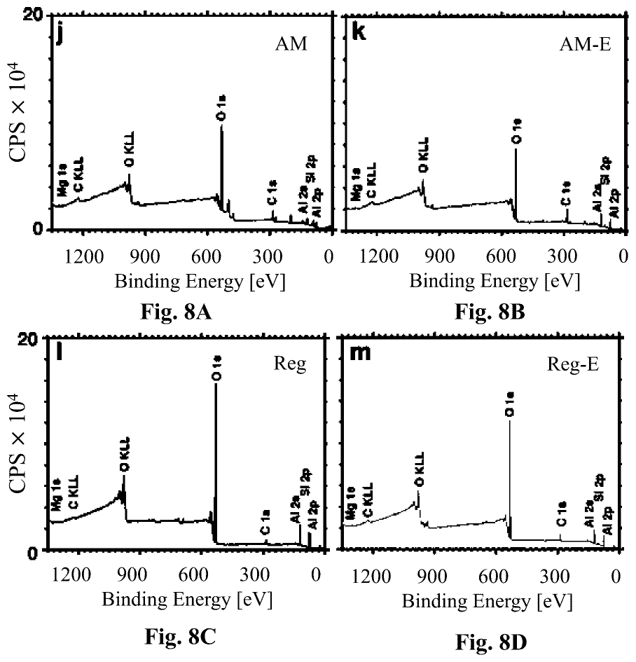

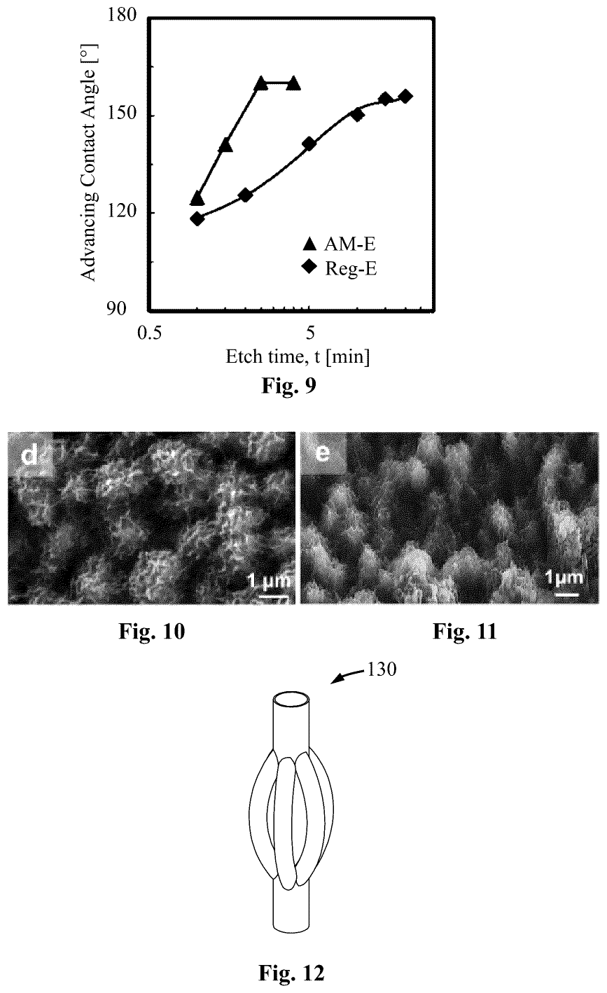

For comparison, a piece of non-additively formed conventional aluminum alloy (Al-6061) was etched with the same etchant for different time durations. FIGS. 7A to 8D show the surface of the conventional aluminum sample after etching for one minute, five minutes, 15 minutes, and 20 minutes, respectively. The conventional aluminum sample does not show a network of cells or a cellular structure similar to the first-tier nanostructure. As expected, etching increases the macroscale roughness of the conventional aluminum sample.

Table 1 and Table 2 show the elemental composition of an additively manufactured AlSi10Mg article and the conventional aluminum alloy sample (Al-6061) before and after etching, obtained from EDS (energy-dispersive spectroscopy) analysis and XPS (X-ray photoelectron spectroscopy) analysis, respectively. The corresponding XPS spectra are shown in FIGS. 8A to 8D. FIG. 8A shows the XPS spectrum of an additively manufactured article. FIG. 8B shows the XPS spectrum of the additively manufactured article of FIG. 8A after etching and before boehmitization. FIG. 8C shows the XPS spectrum of the conventional aluminum sample. FIG. 8D shows the XPS spectrum of the conventional aluminum sample after etching. The data is consistent with the preferential etching and resulting stepped structure of the surface structure obtained according to embodiments of the present disclosure, and which is not present in conventionally formed aluminum alloys (such as Al-6061). The Si 2p content is significantly higher in the additively manufactured aluminum alloy with a cellular surface structure, and this is further enhanced by preferential etching of the aluminum-rich phase.

TABLE 1
Elemental composition of the articles and conventional aluminum alloy
surfaces before and after etching obtained from EDS analysis.

| | AM AlSI10Mg | | | | Al-6061 | | | |
|---|---|---|---|---|---|---|---|---|
| Elements | Al | Si | O | Mg | Al | Si | O | Mg |
| Un-etched (Conc. wt %) | 85.08 | 8.93 | 4.98 | 1.01 | 96.85 | 0.7 | 0.8 | 0.9 |
| Etched (Conc. wt %) | 79.68 | 14.16 | 5.24 | 0.93 | 93.48 | 0.94 | 0.21 | 1.96 |

TABLE 2
Elemental composition of the articles and conventional aluminum alloy
surfaces before and after etching obtained from XPS analysis.

| | AM AlSI10Mg | | | Al-6061 | | |
|---|---|---|---|---|---|---|
| Elements | Al 2p | Si 2p | Mg 1s | Al 2p | Si 2p | Mg 1s |
| Un-etched (Atomic %) | 88.89 | 11.11 | <<1 | ~100 | <<1 | <<1 |
| Etched (Atomic %) | 67.35 | 32.22 | <<1 | 93.31 | 6.69 | <<1 |

According to the embodiment of FIGS. 5A to 5C, following the etching stage, the selected surface is boehmitized. This may involve immersing the article in deionized water for 30 minutes. Throughout the immersion process, the deionized water is preferably maintained at the temperature of 95° C.±2° C. The deionized water causes a self-limiting reaction at the selected surface such that only a thin layer of boehmite of approximately ˜300 nm (nanometers) is formed. The boehmite at the selected surface serve as the second tier nanostructures.

FIG. 11A and FIG. 11B show the SEM images of the top view and side view of the article after the boehmitization procedure. A dense boehmite layer, i.e., a layer of the second-tier nanostructure 120, forms on the cell walls 116 and within the cellular structure, i.e., including the side walls 114 of the cells. The EDS and XPS characterization confirms that the cell walls 116 are composed of silicon-rich phases. The boehmite layer, i.e., the layer of the second tier nanostructures 120, is composed of aluminum-rich phases. The boehmite layer, i.e., the layer of the second tier nanostructure 120, is located on the walls 116, including on the side walls 114 such that the second tier nanostructures extend into the cell cavity 118. The boehmite layer includes numerous boehmite protrusions that form sub-cavities 119. The boehmite protrusions or the second-tier nanostructures in effect reduces the size of the cell cavity 118.

The resulting three-dimensional two-tiered nanostructured surface 100 is preferably functionalized (450) to confer it with superhydrophobicity and/or other properties. The stage of functionalization may involve chemical vapor deposition of heptadecafluorodecyl-trimethoxy-silane (HTMS) at atmospheric pressure using 5% v/v of HTMS-toluene in a sealed container maintained at 90° C. inside an atmospheric pressure furnace for 3 hours. This results in the deposition of a monolayer of HTMS on the article surfaces making the article surfaces hydrophobic.

The etched and functionalized workpieces are characterized with hydrophobic surface. In particular, the contact angle measurement can be performed using a micro-goniometer with ˜100 nL droplets on the articles and the conventional aluminum alloy. A piezoelectric dispenser is set 5-10 mm above the sample surface and the dispenser would dispense microscale droplets on the surface, allowing droplets to accumulate into a larger droplet to measure apparent advancing contact angle (θₐ). To measure apparent receding contact angle (θᵣ), the dispenser is turned off, allowing the water droplet to evaporate. At least three measurements are performed on spatially varying location of each sample surface and at each location an average of 10 sampling points are obtained. All contact angle data are analyzed using the image processing software with an in-built circle fitting algorithm. The maximum measurement errors of θₐ, θᵣ and Δθ are ±3°, ±3° and ±4.2°, respectively. The advancing contact angle of the etched and functionalized workpieces using deionized water droplets increases with etch time (t) but stabilizes at approximately 160° after etching for 2.5 min. The etched and functionalized conventional aluminum alloy exhibits advancing contact angle stabilizing at approximately 155°. The etched and functionalized workpieces are characterized with improved hydrophobicity than the etched and functionalized conventional aluminum alloy.

In comparison, the etched and functionalized workpieces (AM-E), the boehmitized and functionalized workpieces (AM-B), the etched, boehmitized and functionalized conventional aluminum alloy (Reg-EB), and the etched and functionalized conventional aluminum alloy (Reg-E) are characterized with reduced advancing and receding contact angles than the etch, boehmitized and functionalized workpieces (AM-EB), as is shown in Table 3. Only the boehmitized and functionalized conventional aluminum alloy (Reg-B) exhibits higher angles than the etched, boehmitized, and functionalized workpieces (AM-EB).

TABLE 3
Measured apparent advancing (θₐ) and receding (θᵣ) contact angles.

| | Etch time | Boehmitization | Silanization | | | |
|---|---|---|---|---|---|---|
| Sample | (min) | time (min) | time (h) | θₐ [°] | θᵣ [°] | Δθ [°] |
| AM-EB | 2.5 | 30 | 3 | 163.0 | 161.3 | 1.6 |
| AM-E | 2.5 | 0 | 3 | 160.7 | 159.2 | 1.5 |
| AM-B | 0 | 30 | 3 | 154.9 | 153.6 | 1.3 |
| Reg-EB | 15 | 30 | 3 | 161.4 | 160.0 | 1.4 |
| Reg-E | 15 | 0 | 3 | 155.2 | 153.9 | 1.3 |
| Reg-B | 0 | 30 | 3 | 163.3 | 162.0 | 1.3 |

The articles are characterized with improved hydrophobicity as is evidenced in chamber condensation experiments. In one example, chamber condensation experiments are performed in a test facility. The test facility includes an environmental chamber, vapor line, and coolant line. The environment chamber, where the articles to be tested are housed, has an internal diameter of 0.305 m and length of 0.559 m. Both ends of the chamber are sealed with flanges. The chamber is installed with six viewports (5.08 cm diameter ports and 6.35 cm diameter ports), each with diameter of about 6 cm, for visual access. Several feedthrough fittings are mounted on the parameters of the chamber so that thermocouples and resistance temperature detectors (RTDs) can be installed within the chamber to obtain the vapor and coolant temperatures. To monitor the chamber pressure, two pressure transducers have been used with one transducer installed at each end of the chamber. The vapor line consists of a vapor generator filled with the deionized water and a stainless-steel tubing system connecting the pressure vessel to the environmental chamber. To heat up the deionized water, three rope heaters, each of 624 W, are installed on the outer surface of the vapor generator. The rope heaters are connected to a variable power transformer which allows the heaters' heat rate to be controlled. A T-type thermocouple is inserted into the vapor generator to monitor the working fluid's temperature. The coolant line is a closed loop system consisting of a chiller with a build-in water pump. Cold water is supplied from the chiller through the article sample located in the environmental chamber and the water flow rate is measured using an electromagnetic flow meter. The cold-water inlet/outlet temperatures are measured using two RTDs installed at the two ends of the article sample.

Prior to the start of the condensation experiments, the internal walls of the condensation chamber are wiped clean with acetone and isopropyl alcohol to remove any contaminant. The vacuum pump connected to the condensation chamber is then turned on to remove any traces of non-condensable gas from the system. A liquid nitrogen cold trap, installed just before the vacuum pump, allows moisture from the air extracted from the chamber to be removed and assisted in improving the chamber vacuum condition. During the vacuuming process, the tape heaters are concurrently turned on to heat up the deionized water in the vapor generator. It should be noted that, during this process, the valves installed on the article connecting the vapor generator and condensation chamber are kept closed. The deionized water is degassed by heating it to 100° C. for more than 10 minutes. When the chamber pressure is below 50 Pa, the chiller is turned on to allow cold water to circulate through the internal channel of the sample workpiece. During the experiments, the inlet cold water temperature (T_{w,in}) is maintained between 7° C. and 8° C., and the flow rate ranges between 20±0.2 to 30±0.2 L/min, which correspond to the Reynolds number (Re) of 28,000 to 43,000 and Prandtl number (Pr) of approximately 10. The experiments are commenced when the chamber pressure is below 6 Pa±2 Pa. Thereafter, the valve installed on the connecting workpieces between the vacuum pump and condensation chamber is closed and the vacuum pump is switched off. The valve on the vent port of the vapor generator is closed to isolate the vapor generator from ambient pressure. Then the valve connecting the pressure vessel and condensation chamber is gradually opened to achieve the required vapor pressure (Pᵥ). Pᵥ can be varied between 3.2 kPa and 7.5 kPa and the condensation heat transfer coefficients are determined at different Pᵥ values, corresponding to different supersaturation(S).

Stable droplet-jumping condensation occurs on the articles when the articles are exposed to the environments with supersaturation. The articles allow intense droplet jumping and a negligible amount of pinned liquid droplet on its surface. The length scale of the boehmite on the articles is approximately one order of magnitude smaller than the cellular structure length scale. The combination of a dense secondary structure or second-tier nanostructures (boehmite) on the cell walls while still preserving the overall shape of the cellular structure or first-tier nanostructures, results in a structure topology that is advantageous for enhancing droplet jumping and preventing surface flooding. With a second tier boehmite phase forming on the cellular walls, the effective height of the structures further increases, providing an additional energy barrier to impede lateral growth. The two-tier (cellular-boehmite) structures have reduced droplet-surface adhesion compared to the single tier cellular structures, resulting in more frequent droplet jumping. Regarding two adjacent partially wetted droplets immediately prior to coalescence, the work of adhesion is Wₐ=2σₗᵥ{φA_{b}(1+cos θᵣ^{app})+2Aₚ}, where the first term in the brackets corresponds to the adhesion in the non-wetted region of the droplet-surface interface and the second term is associated with the adhesion of the wetted region. The term A_{b} denotes the droplet basal area, φ is the nanostructure solid fraction and Aₚ is the projected area of water-filled cavity in contact with the droplet base. Hence, φA_{b} represents the contact area between the droplet base and the top surface of the nanostructure. Due to the secondary boehmite layer forming atop the cellular structures, the droplet-nanostructure contact area is reduced, giving φ≈φ_{AM-E}·φ_{AM-B}. Hence, the articles have a lower adhesion associated with the non-wetted region. Furthermore, in the wetted region, the presence of boehmite on the inner cell walls prevents condensate from completely filling the cellular cavities. This reduces the water-filled cavity area in contact with the droplet base (Aₚ) and lowers the droplet adhesion in the wetted region.

The articles exhibit higher condensation heat transfer coefficient (h_{c}) than AM and conventional aluminum alloy. This is ascribed to the small droplet departure size and high jumping frequency which allows continuous regeneration of nucleation sites further promoting microdroplet growth. The average droplet departure size is smaller, and presence of pinned droplets on the surface are negligible. Accordingly, the droplet thermal resistances are significantly smaller. Furthermore, as the droplet jumping is consistent and stable throughout the entire range of vapor pressures, no degradation in h_{c} was observed from the experimental results. h_{c} increases with increasing Pᵥ. The increased h_{c} is due to the increased nucleation density at elevated supersaturations, as well as the change in the interfacial mass transfer resistance which is sensitive to vapor pressure and becomes less dominant as vapor pressure increases.

The articles are also characterized with anti-flooding properties in that confinement of the droplet base is prevented. When a nanodroplet nucleates within the cellular cavity, a high local energy barrier imposed by the cell walls limits lateral growth and forces the droplet to grow in the upward direction resulting in the partially wetting state where a Cassie droplet sits atop the nanostructures and a confined liquid-filled region exists beneath the droplet within the cellular cavity. The lateral growth of the droplets is constrained by the cell walls.

The articles are also characterized with corrosion resistance. For example, the corrosion test can be performed in the potentiodynamic polarization using a potentiostat in a sodium chloride (NaCl) solution of 0.5 M NaCl. A three-electrode scheme is used for the electrochemical cell. An Ag/AgCl Sat. KCl is used as the reference electrode and graphite as counter electrode. A 2.6 cm² area from middle of each sample is tested and the whole setup is kept inside a Faraday cage to prevent electrical interference. Each workpiece is immersed in the solution for 1 hour and the open circuit potential test is done prior to the test. The potential range is set to −0.5 to 0.5 V versus corrosion potential and the scan rate is 1 mV/s.

The high corrosion resistance is attributed to the synergistic effect of the boehmite layer, and the additional porous structures introduced by etching. A single tier boehmite layer acts as a barrier to corrosive ions and protects the underlying surface. Furthermore, the air pockets inside the micro/nanostructures of the superhydrophobic surfaces provides additional protection by decreasing the available active area for corrosion. The trapped air within the structures prevents the corrosive ions from attacking the underlying surface. The boehmite layer acts as an additional protective oxide layer to the surface which keeps the underlying porous structures safe from the corrosive ions increasing the long-term stability of the structures. The boehmite layer forms the hierarchical structures which decrease water adhesion, limiting the concentration of the corrosive ions near the surface.

This application also provides a condenser 130 fabricated with the method described above. FIG. 12 schematically illustrates the structure of the condenser 130. The condenser 130 includes a shell-and-workpiece configuration allowing cooling water to flow through an internal flow channel and allowing steam to condense on an external surface. The condenser 130 further includes converging/diverging sections which connect the larger workpieces to smaller workpieces to avoid overhang, enabling the efficient additive manufacturing of the condenser 130 vertically without supports. Furthermore, the monolithic manufacturing of the condenser 130 eliminates joining processes such as welding and reduces water-side pressure drop by the integration of smoother fluidic transitions and bends.

In particular, the condenser 130 is additively manufactured using AlSi10Mg powder with diameters of the powder particles ranging from 20 μm to 63 μm on a low temperature platform. The platform is configured as an aluminum plate. During the SLM process, as the powder melts, ultra-thin molten pools with a diameter of about 50 μm are formed which then cool and solidify, forming a dense solid layer. The SLM technology utilizes a Gaussian distributed Yb:YAG laser source. The laser has a maximum power of 400 W and is used to selectively melt the base metallic powder. By successively melting and fusing the powder bed layer-by-layer three-dimensional parts are formed. The remaining un-melted powder is processed and reused. The SLM280HL AM facility from SLM Solutions is adopted to fabricate the condenser 130 with a laser power of 200 W, a scanning speed of 1300 mm/s and a hatch spacing of 0.08 mm. The condenser 130 is then removed from the base Al plate using a wire electrical discharge machining (EDM).

The condenser 130 is then cleaned after the articles are removed from the aluminum base plate. Subsequently, the condenser 130 is separately immersed in acetone, ethanol and isopropyl alcohol each and ultrasonicated for 10 minutes. Thereafter, the condenser 130 is rinsed with deionized water and dried with nitrogen stream.

Thereafter, the surface of the condenser 130 is cleaned by sonicating in acetone, ethanol and isopropyl alcohol for 10 min each. Once the surface is cleaned and air dried, it is immersed in the Keller's reagent, consisting of 2.5% HNO3, 1.5% HCl, 1% HF and 95% water, for 30 s. The condenser 130 is then further ultrasonicated for 20 min to remove residues and dried with clean nitrogen gas.

Following the etching procedure, the condenser 130 is boehmitized at the surfaces of the condenser. In Particular, the condenser 130 is immersed into pools of deionized water for 30 min. Throughout the immersion process, the deionized water is maintained at the temperature of 95° C.±2° C. The deionized water causes a self-limiting reaction at the condenser surface forming a thin layer of boehmite of approximately ˜300 nm.

After the boehmitization procedure, the condenser 130 is functionalized by chemical vapor deposition of heptadecafluorodecyl-trimethoxy-silane (HTMS) at atmospheric pressure using 5% v/v of HTMS-toluene in a sealed container maintained at 90° C. inside an atmospheric pressure furnace for 3 hours. This results in the deposition of a monolayer of HTMS on the condenser surface making the condenser surfaces hydrophobic.

The condenser 130 allows water condensation on its surface at the vapor pressure of approximately 6.5 kPa. Droplet-jumping condensation is present on the condenser. Due to the intense droplet jumping process and proximity of the smaller workpieces, droplets departing from one workpiece impact adjacent workpieces and, in the process, assisted in the removal of locally pinned droplets, further increasing droplet renewal frequency and improving condenser performance. The condenser 130 is also characterized with anti-flooding condensation on its surface. Compared with conventional condensers, the condenser 130 is more compact and light in terms of weight. The condenser 130 may be configured with further internal structures using additive manufacturing technique to enhance its thermal performance, which is challenging to fabricate with conventional manufacturing methods.

Chamber condensation experiments were conducted after the etching stage to verify the mechanical integrity of the etched article. The results confirm that the etched article can sustain long term operation under a high vacuum pressure environment, at high internal coolant flow rate without exhibiting any sign of leakage or degradation in material integrity.

According to another embodiment of the present disclosure, the additively manufactured aluminum alloy article (such as one of FIG. 13A) is subjected to a stage of heat treatment before the etching stage. For example, the article may be placed in a furnace maintained at a temperature greater than or equal to about 100° C. (±3° C.) to about 400° C. (±3° C.) for about 2 hours. Thereafter, the article may be allowed to cool in ambient air at about 22° C. (±2° C.). The heat treatment process may be include at least one heating stage, at least one stage of constant temperature, and at least one cooling stage. During the heating stage, the rate of heating may range from about 80° C./min to about 10° C./min. The rate of cooling may range from about 1° C./min to about 2° C./min. Before and after the heat treatment, the article may be cleaned as described above. It is observed that the heat treatment promotes the formation of the second-tier nanostructures 120 in the form of nanobumps as a result of precipitation of silicon-nanoparticles from the supersaturated aluminum-phase. The selected surface 100 is then etched using an etchant, e.g., hydrochloric acid (HCl), that is more reactive with the core than with the cell wall. The silicon-nanoparticles do not react with the etchant and remain disposed on the cell wall and extending into the cell cavity. The two-tiered structure is revealed upon preferential etching of the cores over the cell walls.

FIG. 13A to FIG. 13C show the sectional schematic views of the surface morphology evolution of the article 80 before heat treatment and etching, after heat treatment and before etching, and after heat treatment and etching, respectively. The selected surface is characterized with columnar grains 117. After heat treatment, bumps 120 grow on the columnar grains. Grains 117 are rich in the element aluminum and can be etched away in the etching step to form cavities 118. Grains 116 are rich in the element silicon and can remain after etching to form cell walls 116. Boehmite may be formed in the step of boehmitization to define or further the bumps, i.e., the second-tier nanostructure 1224. Grains 117 and 116 may be composed of single crystals and/or multicrystals.

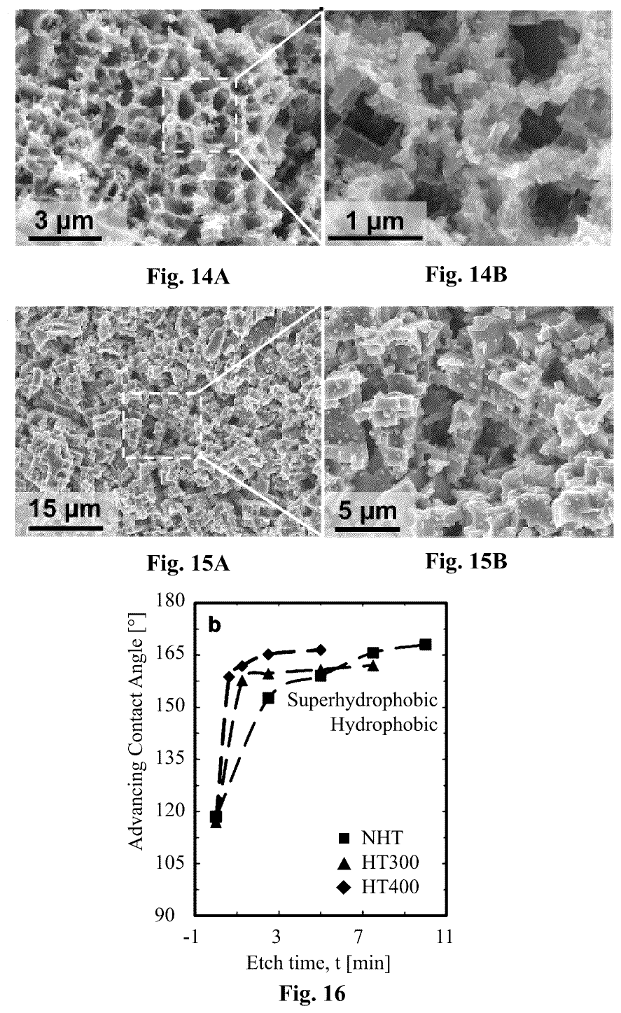

After heat treatment, the article 20 is etched and silanized as described above. FIG. 14A, FIG. 14B, FIG. 15A, and FIG. 15B show the SEM images of the etched and silanized surface 100 heat treated at 300° C. and 400° C., respectively. The SEM images show that second-tier nanostructures in the form of small/smaller bumps (nanobumps) with dimensions in the region of about 10 nm to about 100 nm are disposed on the cell walls. The formation of nanobumps, i.e., protrusions, stems from the precipitation of silicon-nanoparticles from the supersaturated aluminum-phase during thermal treatment.

Heat treatment at a higher temperature (400° C.) leads to significant growth and agglomeration of silicon particles, such that the agglomerations can reach micrometer sizes. This resulted in the complete loss of the cellular boundaries. During etching, the removal of the aluminum which holds the silicon-microparticles in place may also result in silicon-microparticle removal. This generates step-like micro-features with deep cavities, as is shown in FIG. 15A and FIG. 15B.

FIG. 16 shows that the advancing contact angle increases with increasing etch time (t), with eventual stabilization as etch time increases further. The heat-treated and etched surface 100 is also characterized with water droplet bouncing dynamics for anti-flooding jumping-droplet condensation. For example, the heat-treated and etched surface 100 has lower adhesion with water droplets, and more delay in icing time than a conventional aluminum sample. The low adhesion surfaces of the article 100 facilitate facile detachment of condensate droplets during heterogeneous condensation. The heat-treated and etched article 80 repels condensed droplets, prevents lateral growth of nucleated droplets in the cavities, and exhibits droplet jumping. The two-tiered nanostructures of the article 80 induces Laplace pressure gradient on growing droplets during condensation, enabling droplets to self-dislodge from cavities and settle atop surface structures and further reducing droplet-surface adhesion. The heat treated and etched surface 100 is also characterized with mechanical robustness and corrosion resistance.

In another aspect, the present application provides an additively manufactured heat exchanger 130 (e.g., a condenser). The condenser 130 may have at least one surface characterized by a surface property. Examples may include hydrophobicity, water droplet bouncing dynamics for anti-flooding jumping-droplet condensation, lower adhesion with water droplets, and more delay in icing time than conventional counterparts, repelling condensed droplets, preventing lateral growth of nucleated droplets in the cavities, exhibiting droplet jumping, mechanical robustness, and corrosion resistance.

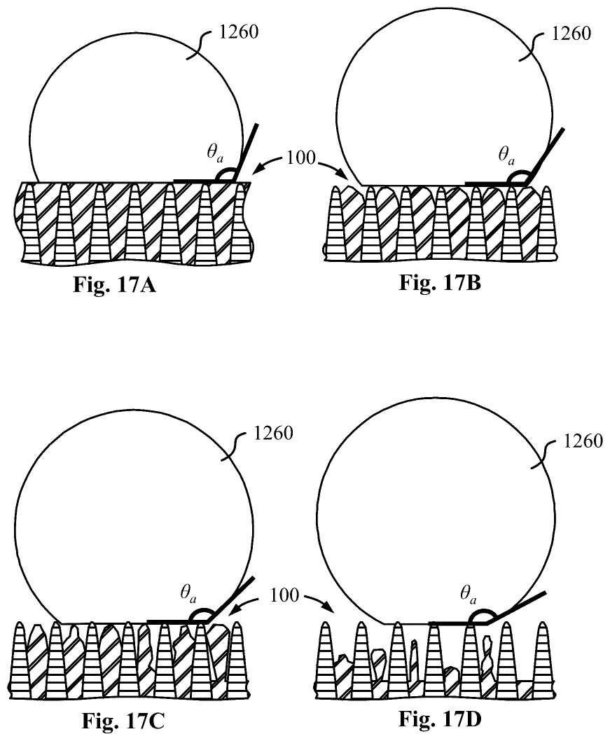

FIG. 17A to FIG. 17D show the water droplet contact angle of the selected surface 100 without etching (FIG. 17A), after etching for 2.5 minutes (FIG. 17B), 5.0 minutes (FIG. 17C), and 7.5 minutes (FIG. 17D), respectively, based on experiments with water droplets 1260. The contact angle, θₐ, increases with etch times. As such, the selected surface 100 after etching is characterized with hydrophobicity.

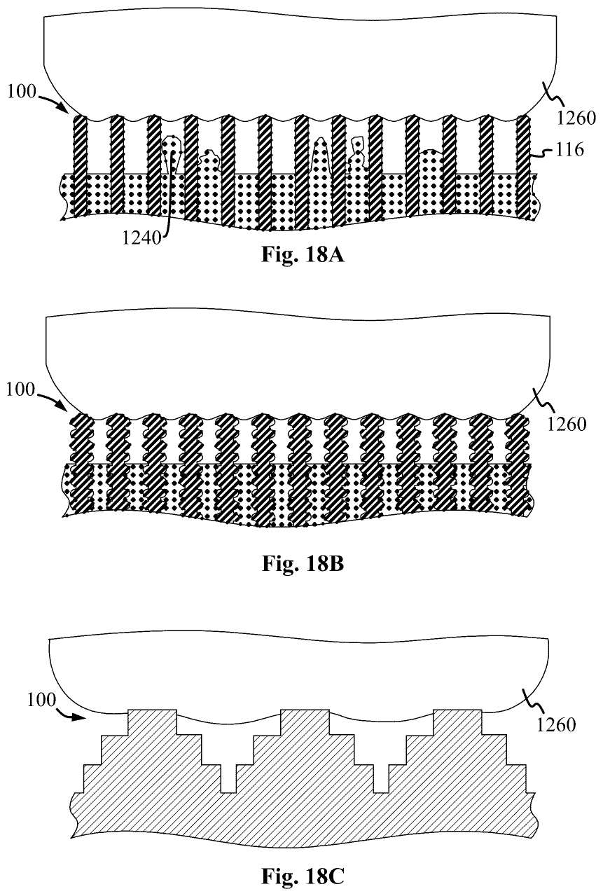

FIG. 18A to FIG. 18C show droplet impact (droplet 20 shown partially) on the selected surface 100 before heat treatment and after etching (FIG. 18A), after heat treatment at 300° C. and etching (FIG. 18B), and after heat treatment at 400° C. and etching (FIG. 18C), respectively. The selected surface 100 heat treated at 400° C. is characterized with a stepped shape surface morphology. The selected surface 100 before heat treatment and after etching is characterized with remaining aluminum-rich grains 1240 confined by the cell walls 116 (FIG. 18A). Remaining aluminum-rich grains 1240 are absent from the selected surface 100 after heat treatment at 300° C. and etching (FIG. 18B) as well as the selected surface 100 after heat treatment at 400° C. and etching (FIG. 18C). It should be appreciated that the grains in FIG. 18A, FIG. 18B, and FIG. 18C can be composed of different phases and/or same phases.

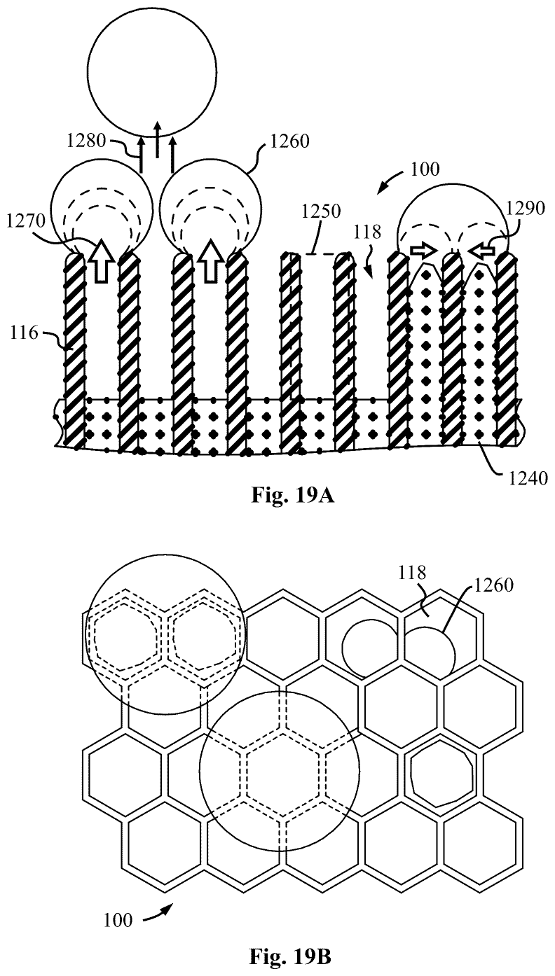

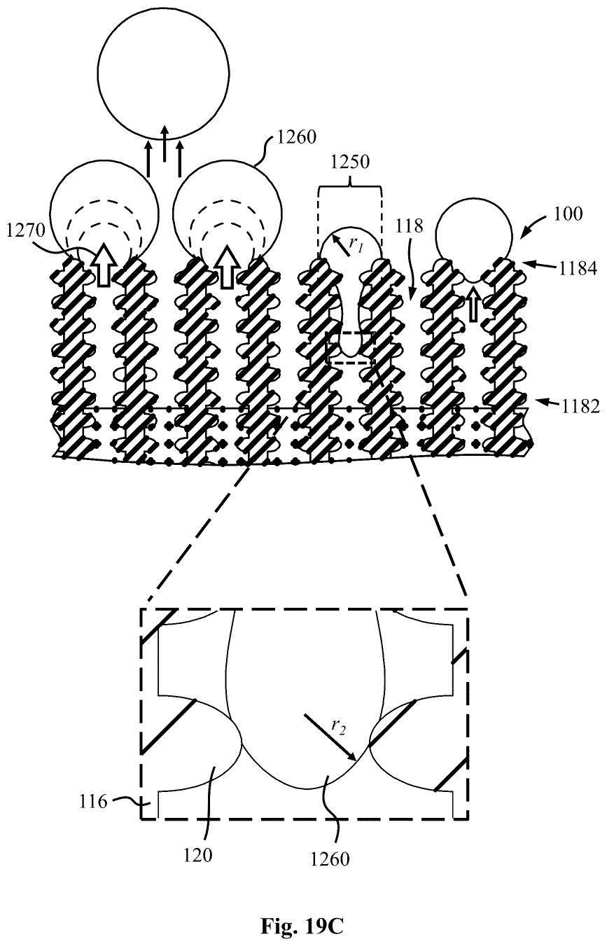

FIG. 19A to FIG. 19C show the droplet departure and droplet pinning mechanism of the article before heat treatment and after etching (FIG. 19A and FIG. 19B), and after heat treatment at 300° C. and etching (FIG. 19C), respectively. The article before heat treatment and after etching defines cells 1250 on its surface 100 and allows growth of water droplet 1260 from a close end of the cavities to an open end of the respective cavities along the elongation direction 1270 of the columnar grains within individual cells 1250, leading to droplet coalescence and droplet departure 1280 from the surface 100 of the article. The article before heat treatment and after etching allows growth 1290 of water droplet perpendicular the elongation direction of the columnar grains on top of individual cells 1250, leading to droplet coalescence and droplet pinning on the surface of the article. The article before heat treatment and after etching also allows pinning of droplets 1260 within individual cells 1250, as is shown in FIG. 19B.

As is shown in FIG. 19C, the article after heat treatment at 300° C. and etching allows growth of water droplet 1260 from a close end 1182 of the cavities 118 to an open end 1184 of the respective cavities along the elongation direction 1270 of the columnar grains, within individual cells 1250, and on top of individual cells 1250, as described above with respect to FIG. 19A. The droplet radius r₁ of a portion of the droplet on top the of cells 1250 is larger than the droplet radius r₂ of a portion of the droplet within cells 1250. The droplet radius r₁ and r₂ cause pressure gradients enabling droplets to self-dislodge from the cavities and to settle atop surface structures. Consequently, the surface of the article is characterized with hydrophobicity.

As described above, the selected surface of the present disclosure is characterized by a two-tier nanostructure: first-tier nanostructures and second-tier nanostructures disposed on at least a cell wall of the first-tier nanostructures. The first-tier nanostructures define a network of cells, each with a cell wall and a recessed core. The core is predominantly formed of a first phase of an additively formed aluminum alloy, and the cell wall is predominantly formed of a second phase of the same additively formed aluminum alloy. A method of forming the two-tier nanostructure includes preferential etching of the core over the cell wall to form a network of open cells, and a self-limiting formation of the second-tier nanostructure to form a plurality of sub-cavities characterized by nanoscale dimensions smaller than the cell opening of a cell.

The present application provides a surface treatment method and a product thereof. The surface treatment method applies to various materials with element segregation. The product fabricated with the method has hydrophobic surface, which is desirable for various applications including condensers, anti-icing devices, anti-fogging devices, and anti-flooding condensation devices. The product exhibits improved hydrophobicity and heat transfer efficiency than conventional counterparts. The product can be also configured with complicated shapes.

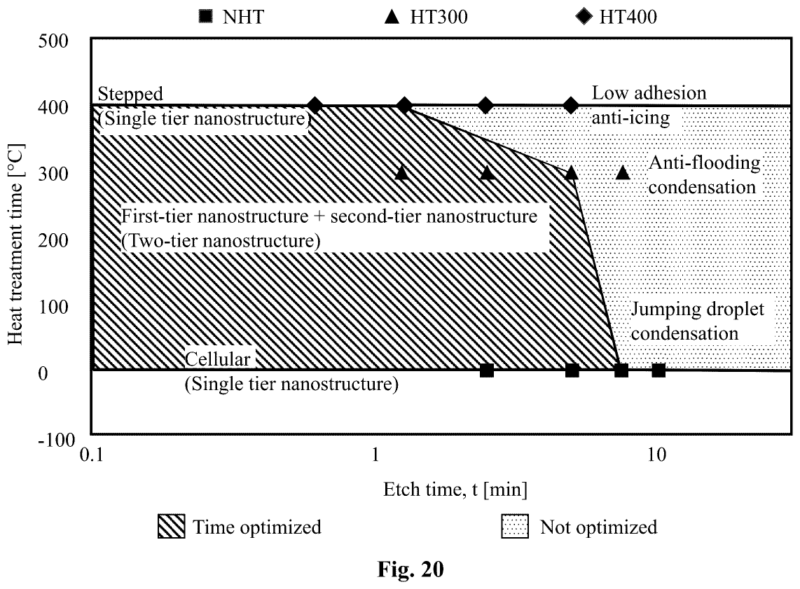

Embodiments of the present disclosure provide the basis for developing a regime map of surface structuring of additively manufactured aluminum alloys, with resulting micro/nanostructures and related performances, such as one illustrated in FIG. 20. The application of the present disclosure to provide an additively manufactured condenser has been described above. For such applications requiring good anti-flooding jumping droplet behavior at high vapor pressures, the surface nanostructuring method involving heat treatment at about 300° C. before etching may be selected. In another example, for applications that require good jumping droplet behavior during condensation at low vapor pressures, the preferred surface structuring may include etching and boehmitization without heat treatment. Embodiments of the present disclosure can also provide a practical way of conferring low droplet adhesion and anti-icing behavior for aircraft and vehicle parts made of aluminum alloys, e.g., by surface structuring method may involve heat treatment at about 400° C. before etching. These and other applications are illustrative and not intended to be exhaustive.

All examples described herein, whether of apparatus, methods, materials, or products, are presented for the purpose of illustration and to aid understanding, and are not intended to be limiting or exhaustive. Various changes and modifications may be made by one of ordinary skill in the art without departing from the scope of the invention as claimed.

1. An article, comprising:
a selected surface having: a first plurality of a first-tier nanostructure; and a second plurality of a second-tier nanostructure,
wherein the first-tier nanostructure includes:
a cell wall, the cell wall being columnar; and
a core, the core being surrounded by the cell wall and recessed inwardly to define a stepped surface relative to a general plane of the selected surface, the stepped surface and the cell wall defining a cell cavity with a cell opening at the selected surface, the cell opening having a cell diameter,
and wherein the second plurality of a second-tier nanostructure is disposed on at least the cell wall of the first-tier nanostructure, the second plurality of the second-tier nanostructure extending into the cell cavity such that the cell cavity includes a plurality of sub-cavities, the plurality of sub-cavities being characterized by nanoscale dimensions smaller than the cell diameter,
and wherein the core is predominantly formed of a first phase of an additively formed aluminum alloy, and wherein the cell wall is predominantly formed of a second phase of the additively formed aluminum alloy.

2. The article according to claim 1, wherein the cell opening is in fluidic communication with the plurality of sub-cavities.

3. The article according to claim 2, wherein the selected surface comprises a network of a plurality of the cell opening, and wherein adjacent ones of the plurality of the cell opening are separated by contiguous ones of a plurality of the cell wall.

4. The article according to claim 3, wherein the first phase of the additively formed aluminum alloy is more reactive in an etchant than the second phase of the additively formed aluminum alloy in the etchant.

5. The article according to claim 1, wherein the additively formed aluminum alloy is formed from a powder of AlSi10Mg, and wherein the second phase of the additively formed aluminum alloy has a higher silicon content relative to the first phase of the additively formed aluminum alloy, wherein the second-tier nanostructure comprises an oxide of the additively formed aluminum alloy.

6. (canceled)

7. The article according to claim 1, wherein the second-tier nanostructure is composed of boehmite.

8. The article according to claim 7, wherein the second plurality of the second-tier nanostructure comprises the second phase of the additively formed aluminum alloy, wherein the second-tier nanostructure is monolite with the cell wall of at least one of the first plurality of the first-tier nanostructure.

9. (canceled)

10. The article according to claim 7, wherein the selected surface is characterized by a surface property resulting from a functionalization of at least the second plurality of the second-tier nanostructure.

11. The article according to claim 7, the article comprising a heat exchanger having: a coolant flow channel; and an external surface of the coolant flow channel, wherein at least a part of the external surface is configured as the selected surface.

12. A method of making the article of claim 1, comprising:
etching a selected surface of the article using an etchant to form a first plurality of a first-tier nanostructure, wherein the first-tier nanostructure includes:
a cell wall, the cell wall being columnar; and
a core, the core being surrounded by the cell wall and recessed inwardly to define a stepped surface relative to a general plane of the selected surface, the stepped surface and the cell wall defining a cell cavity with a cell opening at the selected surface, the cell opening having a cell diameter; and
forming a second plurality of a second-tier nanostructure on at least the cell wall of the first-tier nanostructure, the second plurality of the second-tier nanostructure extending into the cell cavity such that the cell cavity includes a plurality of sub-cavities, the plurality of sub-cavities being characterized by nanoscale dimensions smaller than the cell diameter,
wherein the core is predominantly formed of a first phase of an additively formed aluminum alloy, and wherein the cell wall is predominantly formed of a second phase of the additively formed aluminum alloy.

13. The method according to claim 12, wherein the etching comprises a preferential etching of the first phase of the additively formed aluminum alloy over the second phase of the additively formed aluminum alloy, wherein the etching comprises a preferential etching of the core over the cell wall, forming a network of a plurality of the cell opening, and wherein adjustment ones of the plurality of the cell opening are separated by contiguous ones of a plurality of the cell wall.

14. (canceled)

15. The method according to claim 12, wherein the forming of the second plurality of the second-tier nanostructure comprises a self-limiting formation of the second plurality of the second-tier nanostructure, wherein the second-tier nanostructure is monolithic with the cell wall of at least one be first plurality of the first-tier nanostructure.

16. The article according to claim 15, wherein the second-tier nanostructure is monolithic with the cell wall of at least one of the first plurality of the first-tier nanostructure.

17. The method according to claim 15, wherein the forming of the second plurality of the second-tier nanostructure comprises heat treatment of the selected surface before the etching.

18. The method according to claim 17, wherein the second plurality of the second-tier nanostructure comprises the second phase of the additively formed aluminum alloy.

19. The method according to claim 15, wherein the forming of the second plurality of the second-tier nanostructure comprises boehmitizing the selected surface after the etching.

20. The method according to claim 19, wherein the second-tier nanostructure is composed of boehmite.

21. The method according to claim 15, wherein the additively formed aluminum alloy is formed from a powder of AlSi10Mg, and wherein the second phase of the additively formed aluminum alloy has a higher silicon content relative to the first phase of the additively formed aluminum alloy.

22. The method according to claim 12, further comprising functionalizing the selected surface, the selected surface being characterized by a surface property resulting from a functionalization of at least the second plurality of the second-tier nanostructure.

23. The method according to claim 22, wherein the functionalizing comprises silanizing the selected surface.
